(19) United States
(12) Patent Application Publication
(10) Pub. No.: US 2013/0292491 A1
(43) Pub. Date: Nov. 7, 2013

(54) FLUID HOUSING FOR SPRAY GUN

(71) Applicants: Brian Cvetezar, Manitowoc, WI (US); Ernie Cvetezar, Manitowoc, WI (US); Jeff Cvetezar, Manitowoc, WI (US)

(72) Inventors: Brian Cvetezar, Manitowoc, WI (US); Ernie Cvetezar, Manitowoc, WI (US); Jeff Cvetezar, Manitowoc, WI (US)

(21) Appl. No.: 13/801,390

(22) Filed: Mar. 13, 2013

Related U.S. Application Data
(60) Provisional application No. 61/643,481, filed on May 7, 2012.

(51) Int. Cl. B05B 7/24

(52) U.S. Cl. CPC B05B 7/2472
USPC 239/304; 239/302

(57) ABSTRACT

A fluid housing for a spray gun. The fluid housing includes a body, a pair of inlet passages formed in the body, a pair of side ports formed through the housing body, and a side seal cartridge removably coupled to each side port. Each side port is in fluid communication with a respective inlet passage. Each side seal cartridge includes an internal passage formed therein and a plurality of openings extending from the internal passage at an offset angle. Each side seal cartridge defines a respective longitudinal axis. The fluid housing further includes a seal that is configured to be in compression along the longitudinal axis when a side seal cartridge and engages one of the side ports.

### CROSS-REFERENCE TO RELATED APPLICATIONS

This application claims the benefit of U.S. Provisional Application No. 61/643,481, filed on May 7, 2012. The entire content of the foregoing application is incorporated herein by reference.

### BACKGROUND

Hydraulic fracturing, also referred to as fracking or hydrofracking, may be used to release natural gas and oil from rock formations deep below the earth's surface. In hydraulic fracturing, a hole is first drilled into reservoir rock formations. A pressurized fracking fluid is then injected through the hole. The pressurized fracking fluid can raise the rock or concrete slabs and propagate the fractures of the rock formations, thereby facilitating the extraction and ultimate recovery of the natural gas and oil. To prevent fractures from closing and help maintain the rock slab being raised at the desired level, a fracking fluid may include gels or foams. For example, polyurethane foam can be injected under the slab to fill voids and raise the slab.

A spray gun can be used to inject the polyurethane. The spray gun is typically configured to receive a liquid isocyanate, also referred to as the “A” component, and a liquid blend of polyols, also referred to as the “B” component. These two components are mixed in a mix chamber of the spray gun to form a resin. The resin is purged with pressurized air from a fluid housing of the spray gun.

### SUMMARY

The spray gun typically includes a fluid housing that receives the “A” and “B” components and supplies the two components to a mix chamber for mixing together. The fluid housing first receives the two components from a gun manifold, and then directs the flow of each component to the mix chamber through side seal cartridges. The side seal cartridges are retained in side ports that connect to the mix chamber. In particular, the side seal cartridges are typically spring-loaded within the respective side port to bias the side seal cartridge away from the mix chamber to a predetermined distance.

In hydraulic fracturing, a back pressure tends to develop against the spray gun that is injecting the pressurized fracking fluid. The spring-biased side seal cartridges, when faced with the back pressure during hydraulic fracturing, tend to undesirably leak the mixed polyurethane, allowing the polyurethane to flow back from the mix chamber into various gun components. If this back flow occurs, the spray gun must be completely disassembled and cleaned. Cleaning the spray gun can be time-consuming and cumbersome. Thus, there has developed a need for a spray gun with a fluid housing that can suitably withstand a back pressure during hydraulic fracturing.

According to an embodiment of the invention, a fluid housing is provided for use in a spray gun. The fluid housing includes a body, a pair of inlet passages formed in the body, a pair of side ports formed through the body, and a side seal cartridge removably coupled to each side port. Each side port is in fluid communication with a respective inlet passage. Each side seal cartridge includes an internal passage formed therein and a plurality of openings extending from the internal passage at an offset angle. Each side seal cartridge defines a respective longitudinal axis. The fluid housing further includes a seal that is configured to be in compression along the longitudinal axis when a side seal cartridge engages one of the side ports.

According to another embodiment of the invention, a spray gun is provided for spraying polyurethane. The spray gun includes a gun body including an inlet for connection to a source of pressurized air, a housing body coupled to the gun body, the housing body defining a central bore, a mix chamber insertable into the central bore of the housing body, a pair of inlet passages formed in the housing body, a pair of side ports formed through the housing body, and a side seal cartridge removably coupled to each side port. Each side port is in fluid communication with a respective inlet passage. Each side seal cartridge includes an internal passage formed therein and a plurality of openings extending from the internal passage at an offset angle. Each side seal cartridge defines a respective longitudinal axis. The spray gun further includes a seal configured to be in compression along the longitudinal axis when each of the side seal cartridges engages one of the side ports. One of the side seal cartridge supplies polyisocyanates and the other side seal cartridge supplies polyols through a respective side port to the mix chamber, whereupon the polyisocyanates and polyols are mixed together, thereby forming polyurethane foam. The polyurethane foam is purged from the housing body with the pressurized air.

Other aspects of the invention will become apparent by consideration of the detailed description and accompanying drawings.

### BRIEF DESCRIPTION OF THE DRAWINGS

FIG. 1 is a sectional view of a conventional spray gun.

FIG. 2 is a perspective view of a spray gun, illustrating a fluid housing according to an embodiment of the invention.

FIG. 3 is an exploded view of the spray gun of FIG. 2.

FIG. 4 is an exploded view of the fluid housing of FIG. 2, illustrating side seal cartridges being inserted into the fluid housing.

FIG. 5 is an enlarged perspective view of the fluid housing of FIG. 2.

FIG. 6 is a side view of the fluid housing of FIG. 5.

FIG. 7 is a side view similar to FIG. 6, but from a direction rotated 90° about a longitudinal axis of the fluid housing.

FIG. 8 is a side view similar to FIG. 6, but from a direction rotated 180° about a longitudinal axis of the fluid housing.

FIG. 9 is an end view of the fluid housing of FIG. 6.

FIG. 10 is an end view similar to FIG. 9, but from an opposite direction.

FIG. 11 is an enlarged perspective view of one of the side seal cartridges illustrated in FIG. 4.

FIG. 12 is a side view of the side seal cartridge of FIG. 11.

FIG. 13 is an end view of the side seal cartridge of FIG. 11.

FIG. 14 is an end view similar to FIG. 13, but from an opposite direction.

FIG. 15 is a perspective view of a side seal cartridge according to an alternative construction.

FIG. 16 is an exploded perspective view of the side seal cartridge of FIG. 15.

It should be understood that the invention is not limited in its application to the details of construction and the arrangements of the components set forth in the following description or illustrated in the above-described drawings. The invention is capable of other embodiments and of being practiced or being carried out in various ways. Also, it is to be understood that the phraseology and terminology used herein is for the purpose of description and should not be regarded as limiting.

### DETAILED DESCRIPTION

A “polyurethane foam” as used herein refers to polymers that contain the molecular structure of urethane —(—NH—CO—O—)—, urea —(—NH—CO—NH—)—, or both. Such polymers are typically obtained by reacting polyisocyanates, also referred to as the “A” component, with isocyanate-reactive compounds such as polyols, also referred to as the “B” component, often using foaming agents.

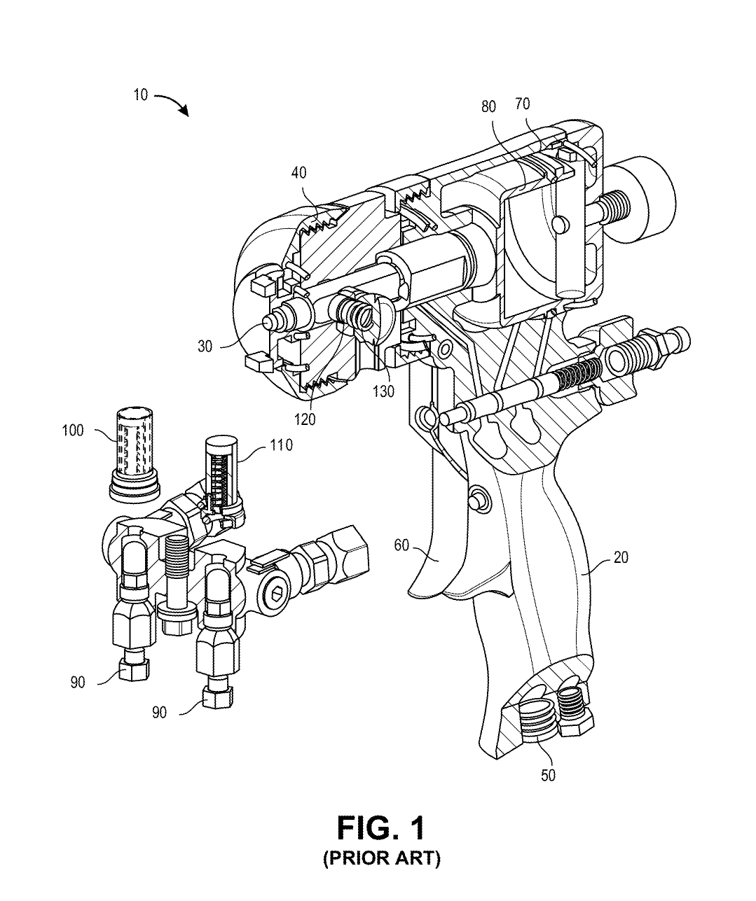

FIG. 1 is a perspective view of a conventional spray gun 10 that is configured to receive “A” and “B” components, to mix the two components, thereby forming a polyurethane foam, and to spray the polyurethane foam with pressurized air. The spray gun 10 includes a body 20, a mix chamber 30, and a fluid housing 40. The body 20 includes an inlet 50 for connection to a source of pressurized air, a trigger 60 for actuation of the spray gun 10, and an air cylinder 70. A piston 80 is slidable in the air cylinder 70 and supplies pressurized air to the mix chamber 30. The mix chamber 30 receives “A” and “B” components from a gun manifold 90. In particular, the “A” and “B” components are supplied upwardly from the gun manifold 90 to the mix chamber 30 through vertically extending check valves 100, 110. As used herein, the terms “top,” “bottom,” “front,” “rear,” “side,” “upwardly,” “downwardly,” and other directional terms are not intended to require any particular orientation, but are instead used for purposes of description only. The flows of the “A” and “B” components are each directed to a respective side seal cartridge 120 (only the “A” side seal cartridge is shown on the fluid housing 40 in FIG. 1; the “B” side seal cartridge is positioned substantially diametrically opposite to the ‘A’ side seal cartridge and therefore would be behind the mix chamber 30). Each side seal cartridge 120 extends at a perpendicular angle relative to the respective check valves 100, 110. The “A” and “B” components are thus laterally supplied to the mix chamber 30, whereupon the two components are mixed together, thereby forming polyurethane foam. The polyurethane foam is purged from the fluid housing 40 of the spray gun 10 with pressurized air.

Each side seal cartridge 120 is retained in a side port (not shown) that is formed through the fluid housing 40. In particular, the side seal cartridges 120 are retained in the respective side port by friction, e.g., by an interference fit. The side seal cartridges 120 each include an internal chamber (not shown) formed therein. The internal chamber of the side seal cartridge 120 receives the respective component from the gun manifold 90 and supplies the component to the mix chamber 30. To maintain a suitable volume of the internal chamber, the side seal cartridge 120 is biased within the respective side port by a respective spring 130. The spring 130 biases the side seal cartridge 100 away from the mix chamber 30 to a predetermined distance.

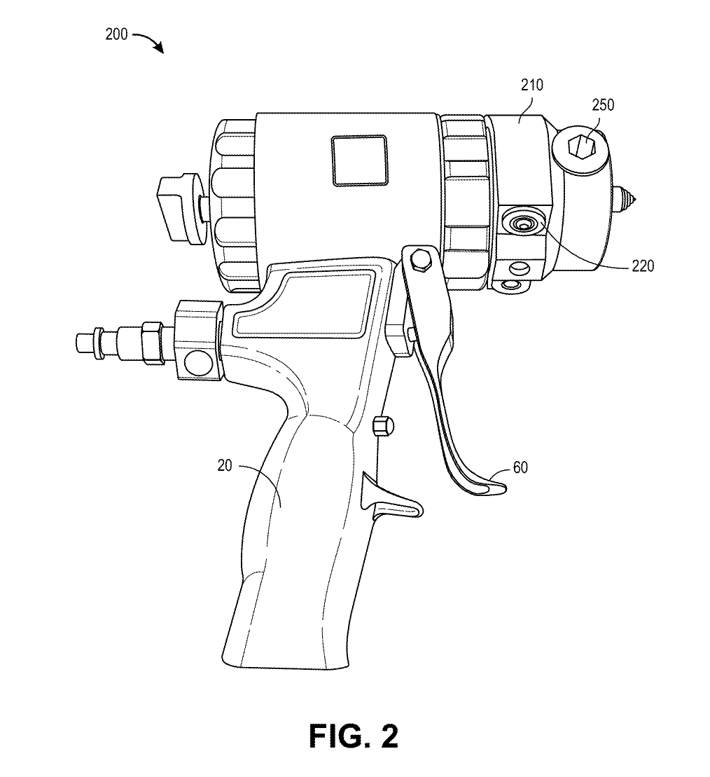

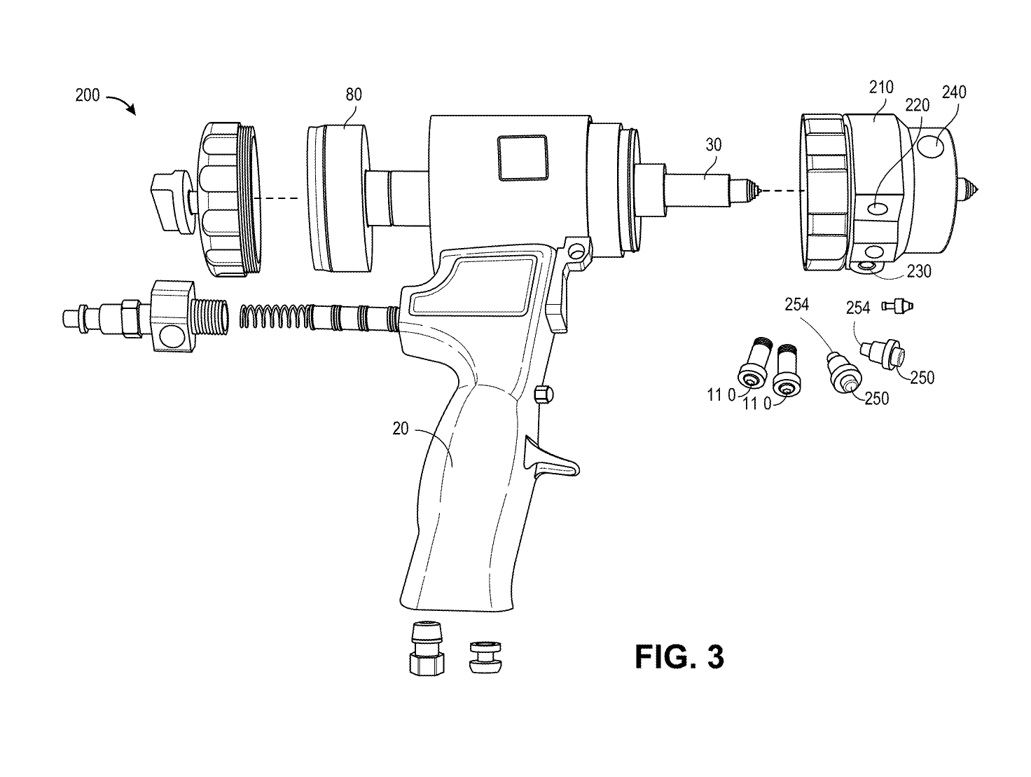

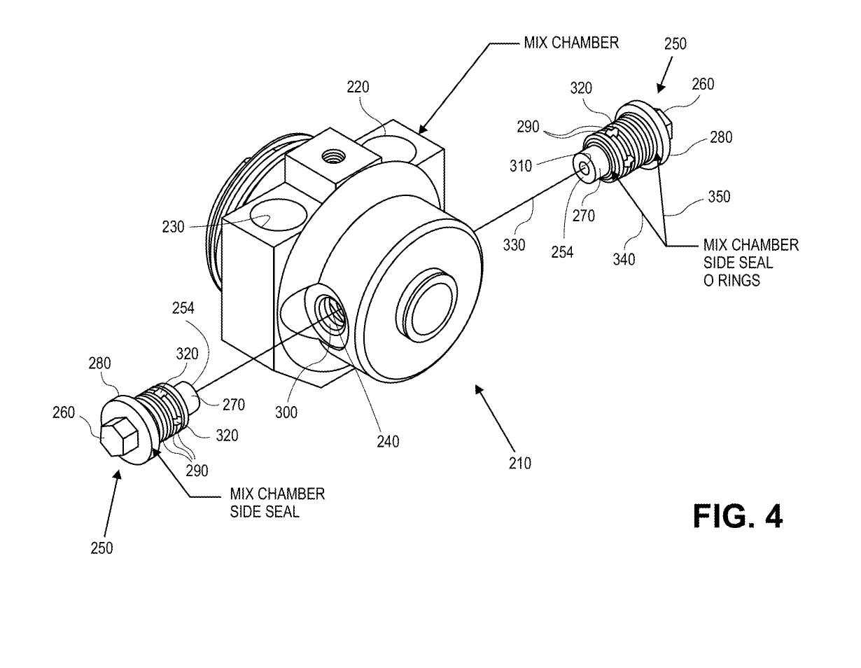

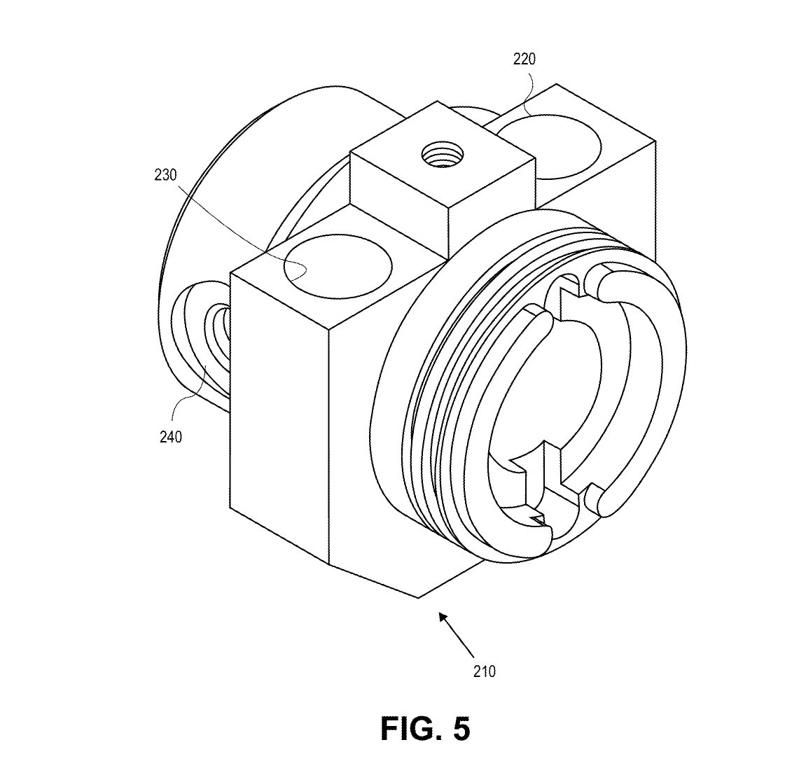

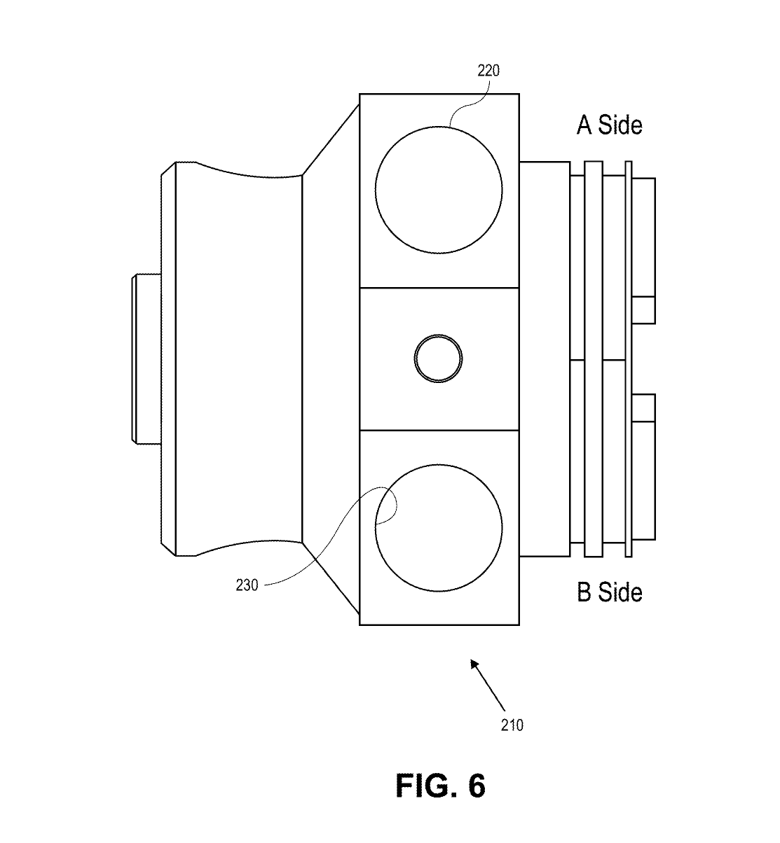

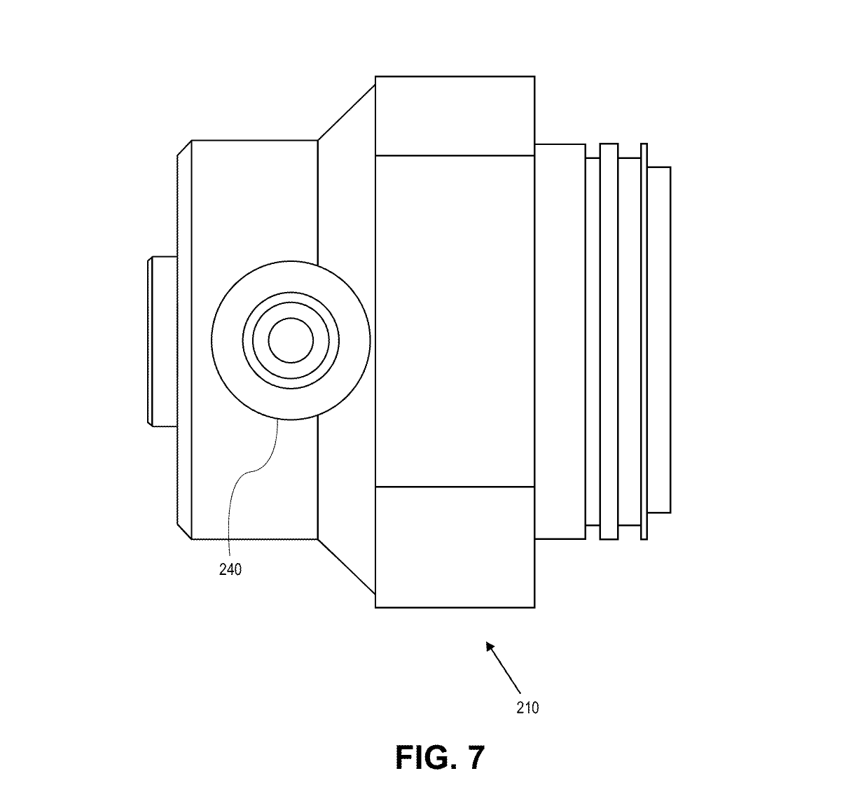

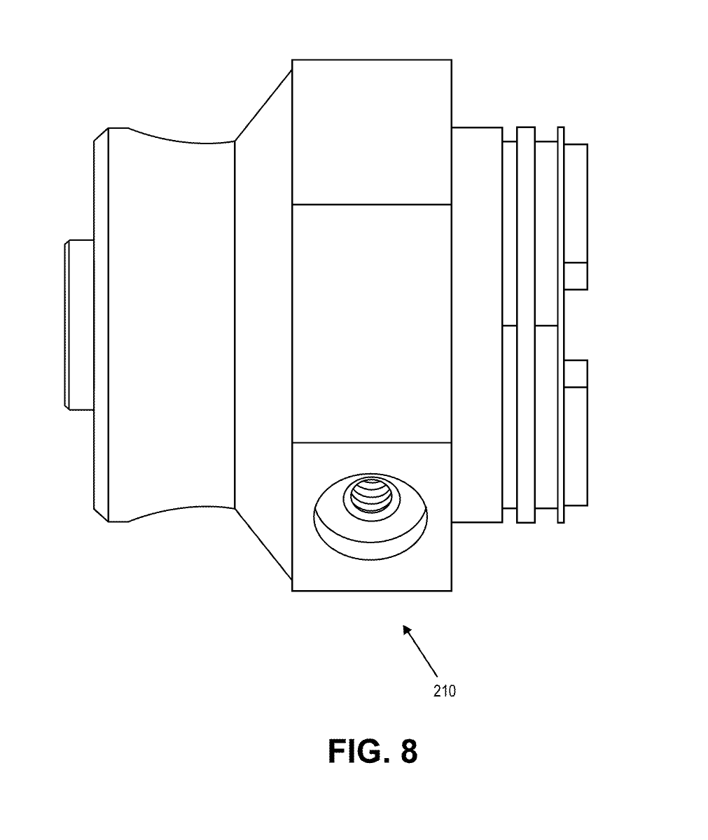

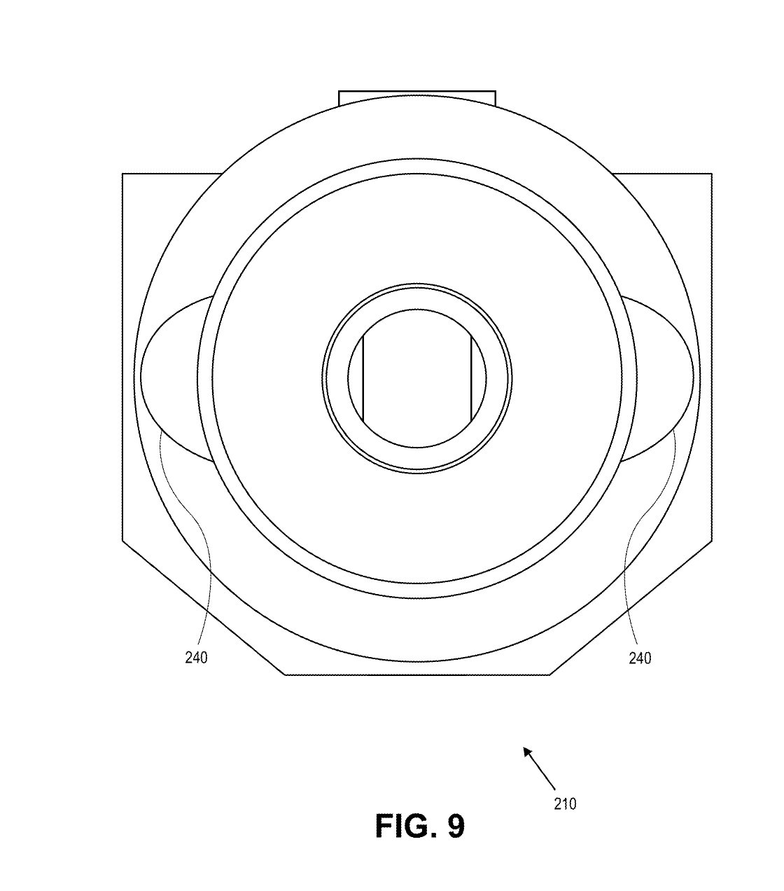

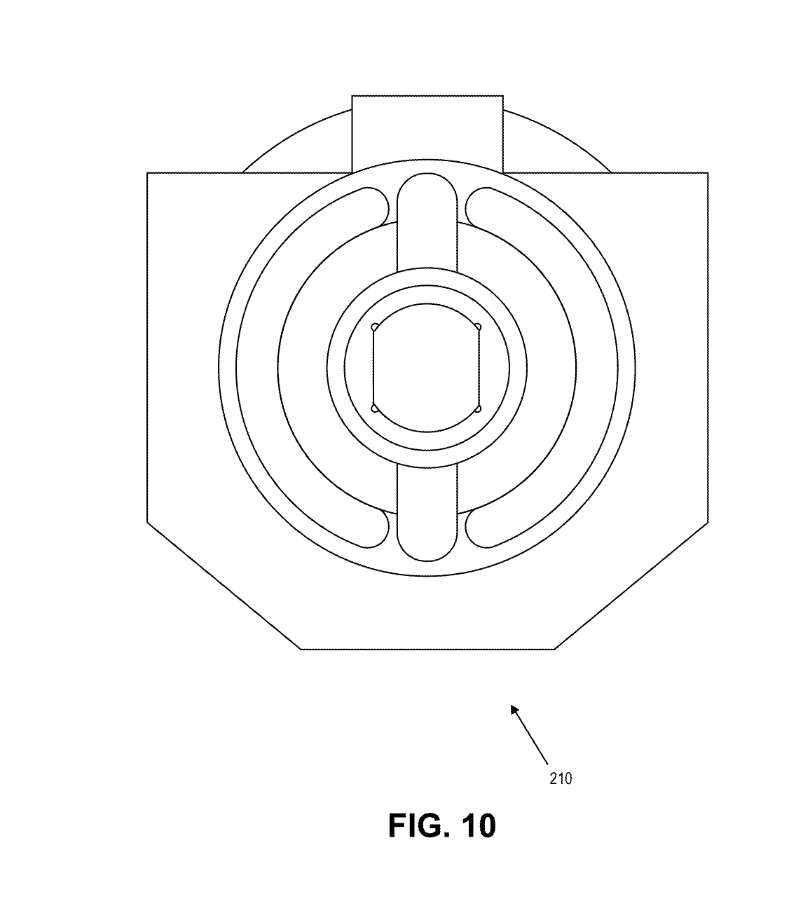

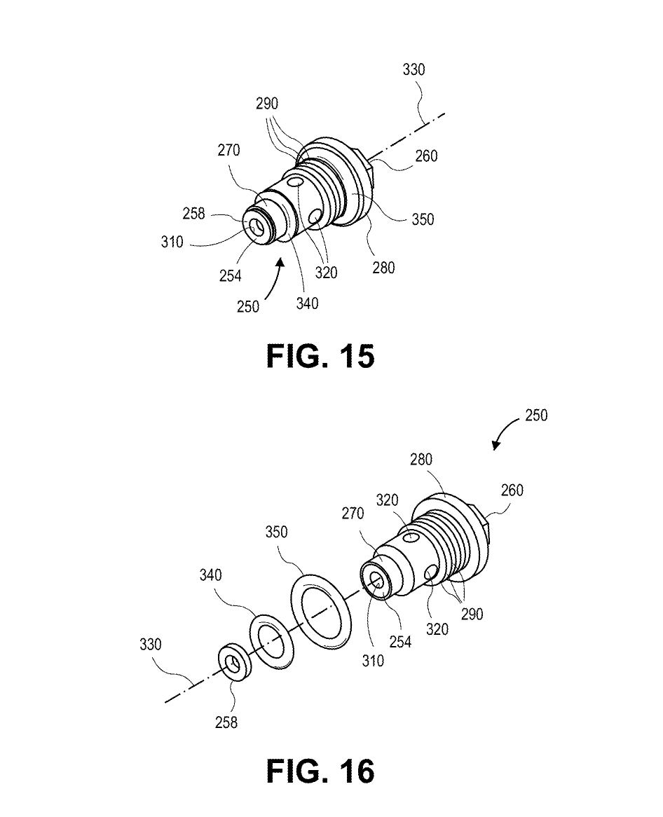

FIGS. 2 and 3 illustrate a spray gun 200 including body 20, a mix chamber 30, and a fluid housing 210 according to an embodiment of the invention. The fluid housing 210 is coupled to the body 20 and defines a central bore, into which the mix chamber 30 is insertable. Referring also to FIGS. 4-10, the housing 210 includes a pair of inlet passages 220, 230 formed therein, and a pair of side ports 240 formed therethrough (only one side port is shown on the fluid housing 210 in FIGS. 3 and 4; the other side port is positioned substantially diametrically opposite to the shown side port and therefore is on a rear side of the housing 210). The housing 210 receives “A” and “B” components from a gun manifold (not shown) through the inlet passages 220, 230, respectively. The inlet passages 220, 230 are in fluid communication with respective side ports 240. Side seal cartridges 250 are received into each side port 240. Each side seal cartridge 250 includes an end portion 254, which is substantially flush with the central bore when the side seal cartridge 250 engages one of the side ports 240. Referring also to FIGS. 15 and 16, in the illustrated embodiment, the end portion 254 of the side seal cartridge 250 includes a recess formed therein, and an annular brass insert 258 is at least partially matingly received in the recess. In other embodiments, the end portion 254 may be formed of a substantially unitary member.

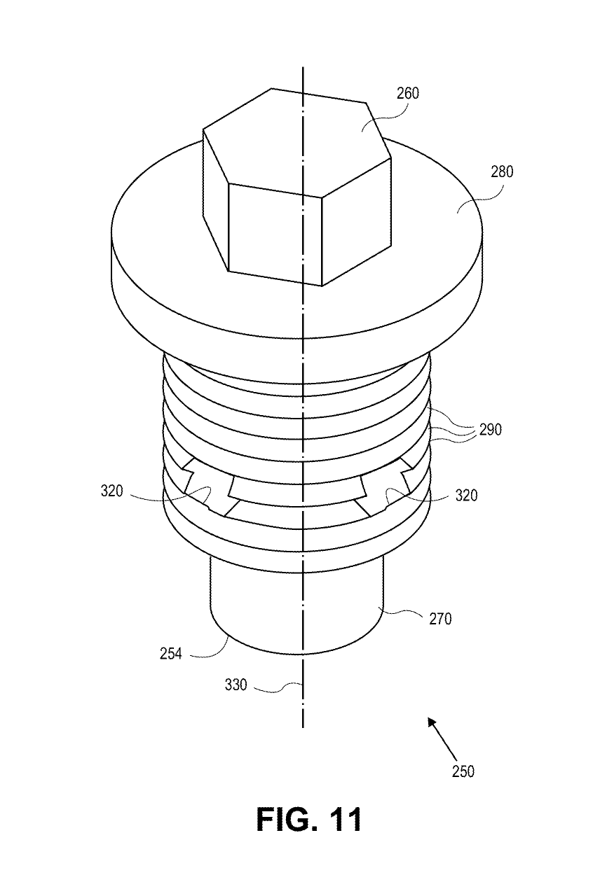

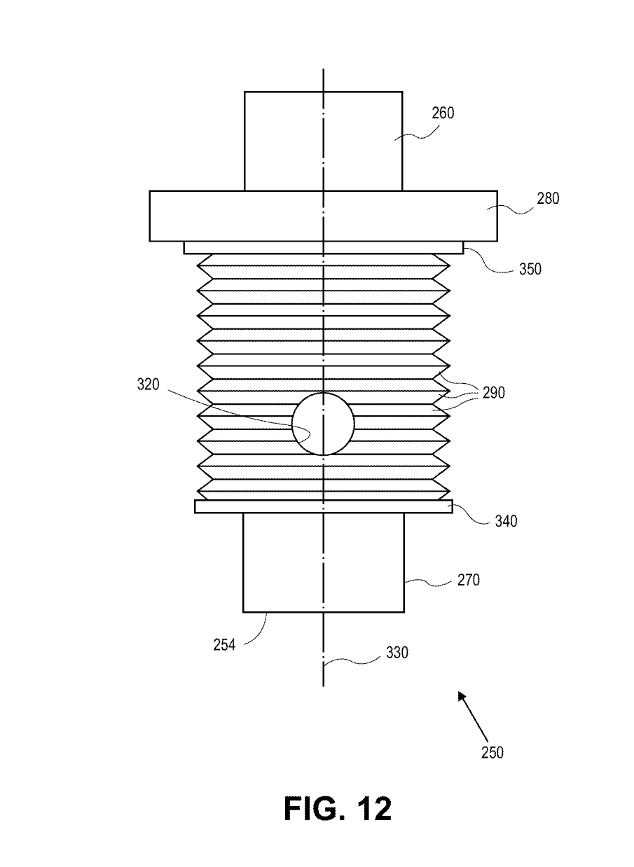

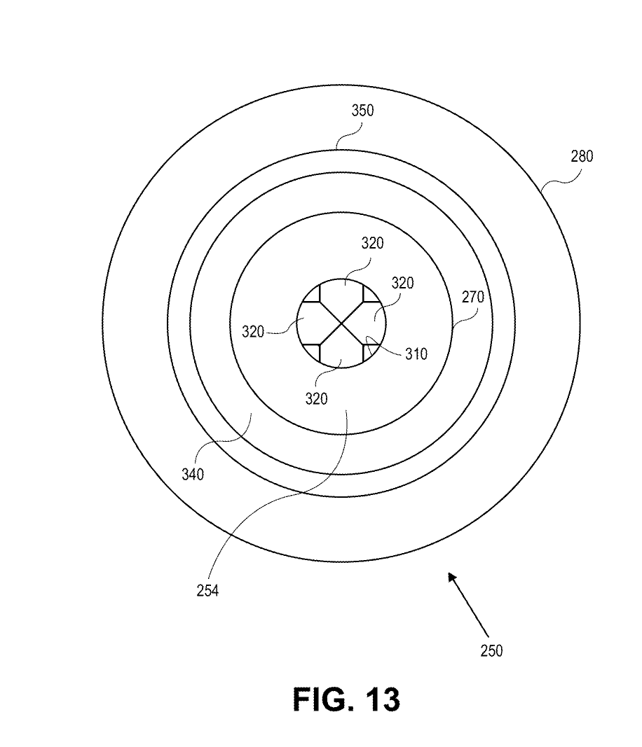

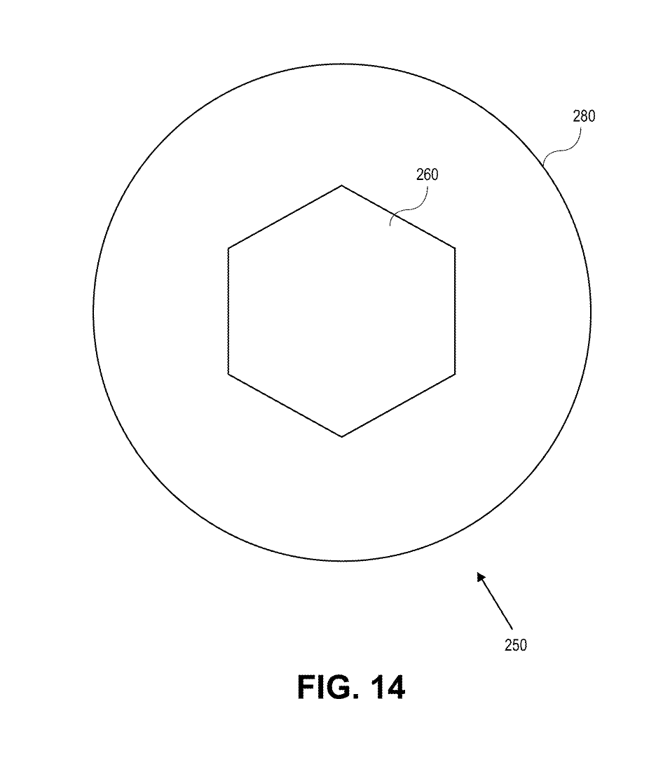

Referring to FIGS. 11-14, and an alternative construction illustrated in FIGS. 15-16, each side seal cartridge 250 includes a head 260, a male member 270, and a flange 280 interposed between the head 260 and the male member 270. The head 260 is generally hexagonal in cross section, having six faces that can be used for fastening. In other embodiments, however, the head 260 may include any other number of faces suitable for fastening. The male member 270 includes a first portion having threads 290 on an outer surface thereof. The threads 290 correspond to threads 300 (see FIG. 4) formed on a mating surface of the side port 240. Although the illustrated embodiment includes threads 290, 300 to secure the side seal cartridge 250 into each side port 240, it is to be appreciated that in other embodiments the side seal cartridge 250 may be secured to the side port 240 using any suitable fastening mechanism(s) including for example, welds or adhesives, or other fasteners that provide a compressive force. The male member 270 also includes a reduced-diameter portion extending from the first portion.

The side seal cartridge 250 includes an internal passage 310 formed therein and a plurality of openings 320 extending from the internal passage at an offset angle. The plurality of openings 320 are positioned on the male member 270 within the threaded section 290 and are spaced apart around an outer circumference of the male member 270. In an alternative construction, illustrated in FIGS. 15-16, the plurality of openings 320 are positioned on the male member 270 on a non-threaded section thereof.

With continued reference to FIGS. 11-14, and the alternative construction illustrated in FIGS. 15-16, the male member 270 defines a longitudinal axis 330, and the internal passage 310 extends substantially parallel to the longitudinal axis 330. In other embodiments, however, the internal passage 310 may extend in a direction offset from the longitudinal axis 330. In the illustrated embodiment, the side seal cartridge 250 includes four openings 320 that extend in radial directions and at a right angle to one another. Each of the openings 320 intersects the internal passage 310 to establish fluid communication therewith. In other embodiments, the openings 320 may not extend in radial directions or at a right angle to one another. In still other embodiments, the side seal cartridge 250 may include any number of openings 320.

A seal is formed at an interface where the side seal cartridge 250 and the side port 240 engage each other. In the illustrated embodiment, the seal cartridge 250 includes a first O-ring 340 positioned at an underside of the threads 290 of the male member 270 and a second O-ring 350 positioned at an underside of the flange 280. The first and second O-rings 340, 350 can help avoid back flow of the polyurethane foam from the mix chamber 30 into various parts of the spray gun 200, as will be explained further below.

In view of the back pressure that tends to push the polyurethane foam in the mix chamber 30 outward and back into the side seal cartridges 250 and ultimately into various parts of the spray gun 200, the first O-ring 340 provides a first line of defense. That is, the polyurethane foam of the mix chamber 30 would be first compressed against the first O-ring 340 in case of a back flow. Unlike in prior-art side seal cartridges 120 that are elastically coupled to the side port, the side seal cartridges 250 are fixedly coupled or secured to the side ports 240, while being removable therefrom, e.g., via the threads 290, 300. The first O-ring 340 on the side seal cartridge 250 is thus held in place when experiencing back pressure, thereby preventing undesirable leakage of the polyurethane foam. The second O-ring 350 provides a second line of defense. Even if the polyurethane foam flows back from the mix chamber 30 into the internal passage 310, the polyurethane foam would be compressed against the second O-ring 350. The second O-ring 350 prevents undesirable leakage of the polyurethane foam into various parts of the spray gun 200. Although in the illustrated embodiment, the side seal cartridge 250 includes both the first and second O-rings 340, 350, it is to be appreciated that, in other embodiments, one or more of the side seal cartridges 250 may include fewer than all of the first and second O-rings 340, 350. In still other embodiments, one or more of the side seal cartridges 250 may include other sealing mechanisms that may suitably provide a compressible seal at an interface where the side seal cartridge 250 and the side port 240 engage each other.

It is understood that the invention may embody other specific forms without departing from the spirit or central characteristics thereof. The disclosure of aspects and embodiments, therefore, are to be considered as illustrative and not restrictive. While specific embodiments have been illustrated and described, other modifications may be made without significantly departing from the spirit of the invention.

Various features and advantages of the invention are set forth in the following claims.

What is claimed is:

1. A spray gun fluid housing comprising:
a body;
a pair of inlet passages formed in the body;
a pair of side ports formed through the body, each side port in fluid communication with a respective inlet passage;
a side seal cartridge removably coupled to each side port, each side seal cartridge including an internal passage formed therein and a plurality of openings extending from the internal passage at an offset angle, each side seal cartridge defining a respective longitudinal axis; and
a seal configured to be in compression along the longitudinal axis when a side seal cartridge engages one of the side ports.

2. The fluid housing of claim 1, wherein at least one side port includes inner threads on an inner surface, and wherein at least one side seal cartridge includes outer threads on an outer surface thereof for engaging the inner threads.

3. The fluid housing of claim 2, wherein each side seal cartridge includes a tip portion recessed relative to the threads, and wherein each seal is provided at the tip portion.

4. The fluid housing of claim 3, wherein each side port includes an annular surface extending from the inner threads, and wherein each seal is in compression against the annular surface when the pair of side seal cartridges engages a respective one of the side ports.

5. The fluid housing of claim 3, wherein at least one side seal cartridge defines a flange distal to the tip portion, wherein at least one side port includes an annular surface recessed relative to the body and configured to engage the flange, the fluid housing further comprising a second seal at a second interface where the pair of flanges and annular surfaces engage each other.

6. The fluid housing of claim 2, wherein each side seal cartridge is secured into the side port solely by the outer threads engaging the inner threads.

7. The fluid housing of claim 1, wherein each side seal cartridge defines an underside, and wherein each seal is positioned at the underside.

8. The fluid housing of claim 1, wherein at least one side seal cartridge includes a head for fastening unto a respective side port.

9. The fluid housing of claim 8, wherein the head includes a plurality of faces to facilitate fastening the side seal cartridge unto the respective side port.

10. The fluid housing of claim 1, wherein the body defines a central bore, wherein at least one side seal cartridge includes a tip portion, and wherein the tip portion is substantially flush with the central bore when the side seal cartridge engages one of the side ports.

11. A spray gun for spraying polyurethane, the spray gun comprising:
a gun body including an inlet for connection to a source of pressurized air;
a housing body coupled to the gun body, the housing body defining a central bore;
a mix chamber insertable into the central bore of the housing body;
a pair of inlet passages formed in the housing body;
a pair of side ports formed through the housing body, each side port in fluid communication with a respective inlet passage;
a side seal cartridge removably coupled to each side port, each side seal cartridge including an internal passage formed therein and a plurality of openings extending from the internal passage at an offset angle, each side seal cartridge defining a respective longitudinal axis; and
a seal configured to be in compression along the longitudinal axis when each of the side seal cartridges engages one of the side ports, one of the side seal cartridges configured to supply polyisocyanates and the other side seal cartridge configured to supply polyols through a respective side port to the mix chamber, whereupon the polyisocyanates and polyols are mixed together, thereby forming polyurethane foam, and wherein the polyurethane foam is purged from the housing body with the pressurized air.

12. The spray gun of claim 11, wherein at least one side port includes inner threads on an inner surface, and wherein at least one side seal cartridge includes outer threads on an outer surface thereof for engaging the inner threads.

13. The spray gun of claim 12, wherein each side seal cartridge includes a tip portion recessed relative to the threads, and wherein each seal is provided at the tip portion.

14. The spray gun of claim 13, wherein each side port includes an annular surface extending from the inner threads, and wherein each seal is in compression against the annular surface when the pair of side seal cartridges engages a respective one of the side ports.

15. The spray gun of claim 13, wherein at least one side seal cartridge defines a flange distal to the tip portion, wherein at least one side port includes an annular surface recessed relative to the housing body and configured to engage the flange, the fluid housing further comprising a second seal at a second interface where the pair of flanges and annular surfaces engage each other.

16. The spray gun of claim 12, wherein each side seal cartridge is secured into the side port solely by the outer threads engaging the inner threads.

17. The spray gun of claim 11, wherein each side seal cartridge defines an underside, and each seal is positioned at the underside.

18. The spray gun of claim 11, wherein at least one side seal cartridge includes a head for fastening unto a respective side port.

19. The spray of claim 18, wherein the head includes a plurality of faces to facilitate fastening the side seal cartridge unto the respective side port.

20. The spray gun of claim 11, wherein at least one side seal cartridge includes a tip portion, and wherein the tip portion is substantially flush with the central bore when the side seal cartridge engages one of the side ports.
